(19) United States
(12) Patent Application Publication
(10) Pub. No.: US 2011/0012908 A1
(43) Pub. Date: Jan. 20, 2011

(54) System for compensation of differential aging mura of displays

(75) Inventor: Scott J. Daly, Kalama, WA (US)

Correspondence Address: KEVIN L. RUSSELL;CHERNOFF, VILHAUER, MCCLUNG & STENZEL LLP, 1600 ODSTOWER, 601 SW SECOND AVENUE, PORTLAND, OR, 97204, US

(73) Assignee: Sharp Laboratories of America, Inc.

(21) Appl. No.: 12/460,551

(22) Filed: Jul. 20, 2009

(51) Int. Cl. G09G 5/00

(52) U.S. Cl. 345/581; 349/102

(57) ABSTRACT

A light shield sized to engage over a major portion of a display to substantially inhibit light from reaching a region between the light gathering element and the display. An optical coupling element is associated with the light gathering element to direct light emanating from the display to a light sensitive element in order to determine corrective data to reduce mura effects.

### CROSS-REFERENCE TO RELATED APPLICATIONS

None

### BACKGROUND OF THE INVENTION

The present invention relates to a system for reducing mura defects in a displayed image.

The number of liquid crystal displays, electroluminescent displays, organic light emitting devices, plasma displays, and other types of displays are increasing. The increasing demand for such displays has resulted in significant investments to create high quality production facilities to manufacture high quality displays. Despite the significant investment, the display industry still primarily relies on the use of human operators to perform the final test and inspection of displays. The operator performs visual inspections of each display for defects, and accepts or rejects the display based upon the operator's perceptions. Such inspection includes, for example, pixel-based defects and area-based defects. The quality of the resulting inspection is dependent on the individual operator which are subjective and prone to error.

“Mura” defects are contrast-type defects, where one or more pixels is brighter or darker than surrounding pixels, when they should have uniform luminance. For example, when an intended flat region of color is displayed, various imperfections in the display components may result in undesirable modulations of the luminance. Mura defects may also be referred to as “Alluk” defects or generally non-uniformity distortions. Generically, such contrast-type defects may be identified as “blobs”, “bands”, “streaks”, etc. There are many stages in the manufacturing process that may result in mura defects on the display.

Mura defects may appear as low frequency, high-frequency, noise-like, and/or very structured patterns on the display. In general, most mura defects tend to be static in time once a display is constructed. However, some mura defects that are time dependent include pixel defects as well as various types of non-uniform aging, yellowing, and burn in. Display non-uniformity deviations that are due to the input signal (such as image capture noise) are not considered mura defects.

Referring to FIG. 1, mura defects from an input image 170 which is adjusted in its tone scale 160 may occur as a result of various components of the display. The combination of the light sources (e.g., fluorescent tubes or light emitting diodes) and the diffuser 150 results in very low frequency modulations as opposed to a uniform field in the resulting displayed image. The LCD panel itself may be a source of mura defects because of non-uniformity in the liquid crystal material deposited on the glass. This type of mura tends to be low frequency with strong asymmetry, that is, it may appear streaky which has some higher frequency components in a single direction. Another source of mura defects tends to be the driving circuitry 120, 130, 140 (e.g., clocking noise) which causes grid like distortions on the display. Yet another source of mura defects is pixel noise, which is primarily due to variations in the localized driving circuitry (e.g., the thin film transistors) and is usually manifested as a fixed pattern noise.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates liquid crystal devices and sources of mura.

FIG. 2 illustrates capturing mura tonescale.

FIG. 3 illustrates loading correction mura tonescales.

FIG. 4 illustrates input imagery and loaded mura correction tonescale.

FIG. 5 illustrates contrast sensitivity function dependence on viewing angle.

FIG. 6 illustrates a contrast sensitivity model to attenuate the mura correction to maintain a higher dynamic range.

FIG. 7 illustrates examples of mura correction with and without using the contrast sensitivity model.

FIG. 8 illustrates an original luminance without correction.

FIG. 9 illustrates brute-force mura correction.

FIG. 10 illustrates single image mura correction.

FIG. 11 illustrates a delta curve for a single image mura correction.

FIG. 12 illustrates a delta curve for a brute force mura correction.

FIG. 13 illustrates original luminance without correction.

FIG. 14 illustrates multiple image mura correction.

FIG. 15 illustrates a delta curve for multiple image mura correction.

FIG. 16 illustrates a block diagram for mura correction.

FIG. 17 illustrates a display, a light shield, an optical coupler, and a light sensitive element.

FIG. 18 illustrates the light shield of FIG. 17 closer to the display.

FIG. 19 illustrates the light shield of FIG. 17 engaged with the display.

FIG. 20 illustrates the optical coupler centered in the light shield.

FIG. 21 illustrates a close up of the light shield and display.

FIG. 22 illustrates a calibration apparatus.

FIG. 23 illustrates the measurement of mura of a display.

FIG. 24 illustrates a mura compensated display.

FIG. 25 illustrates calibration of a display with an associated graphics card.

### DETAILED DESCRIPTION OF PREFERRED EMBODIMENT

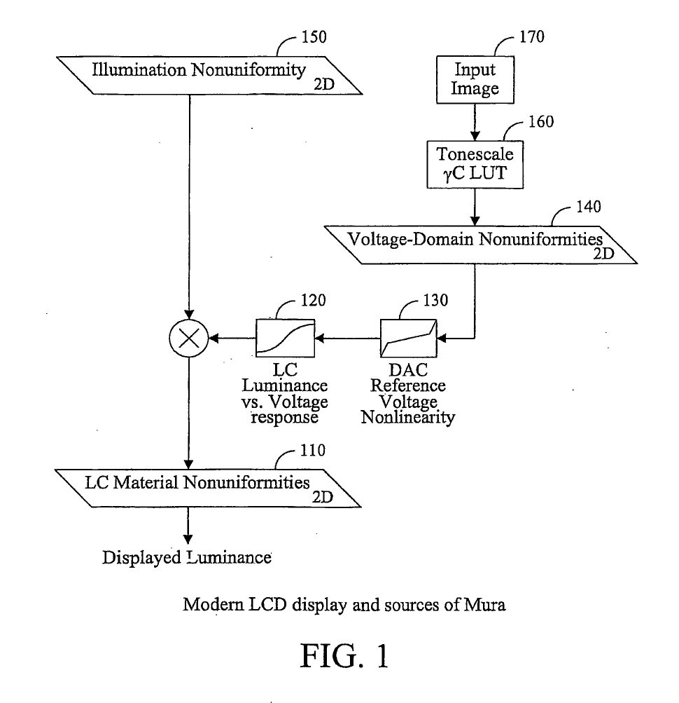

The continual quality improvement in display components reduces mura defects but unfortunately mura defects still persist even on the best displays. Referring to FIG. 1, identification of mura defects is not straightforward because the source of the mura arise in different luminance domains. The mura resulting from the illumination source occurs in the linear luminance domain. To compensate for this effect from the linear domain, the LCD luminance image is divided by the mura and then re-normalized to the desired maximum level. This effect in the linear domain may also be compensated by addition in the log domain. Unfortunately, the data displayed on the image domain of the image in the LCD code value space is neither linear nor log luminance. Accordingly, for correction of illumination-based mura, the LCD image data should be converted to either of these domains for correction.

The mura defects due to the thin film transistor noise and driver circuits does not occur in the luminance domain, but rather occurs in the voltage domain. The result manifests itself in the LCD response curse which is usually an S-shaped function of luminance.

Variations in the mura effect due to variations in liquid crystal material occur in yet another domain, depending on if it is due to thickness of the liquid crystal material, or due to its active attenuation properties changing across the display.

Rather than correct for each non-uniformity in their different domains, a more brute-force approach is to measure the resulting tone scale for each pixel of the display. The low frequency mura non-uniformities as well as the higher frequency fixed pattern mura non-uniformity will appear as distortions in the displayed tone scale. For example, additive distortions in the code value domain will show up as vertical offsets in the tone scale's of the pixels affected by such a distortion. Illumination based distortions which are additive in the log domain will show up as non-linear additions in the tone scale. By measuring the tone scale per pixel, where the tone scale is a mapping from code value to luminance, the system may reflect the issues occurring in the different domains back to the code value domain. If each pixel's tonescale is forced to be identical (or substantially so), then at each gray level all of the pixels will have the same luminance (or substantially so), thus the mura will be reduced to zero (or substantially so).

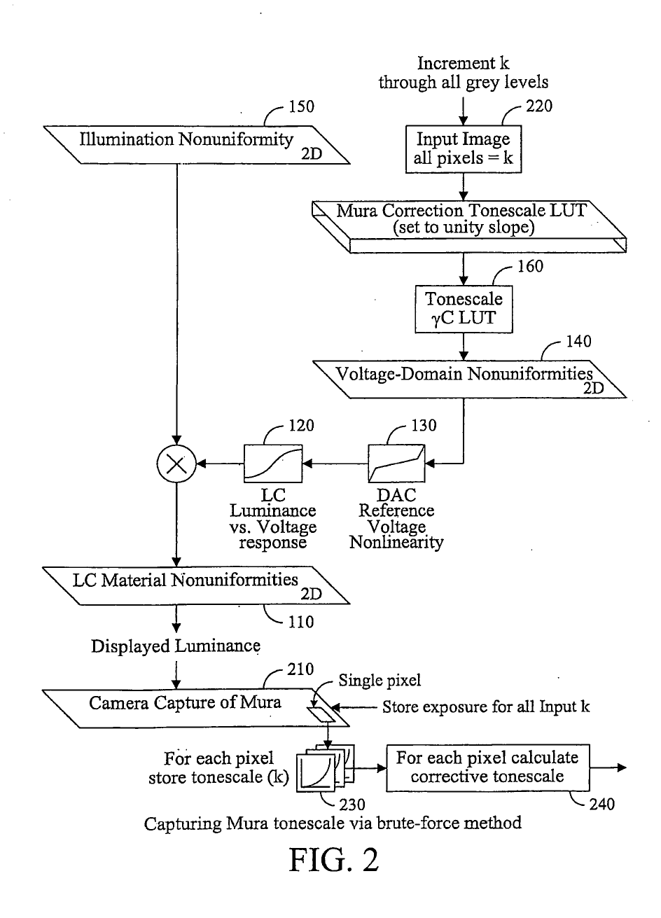

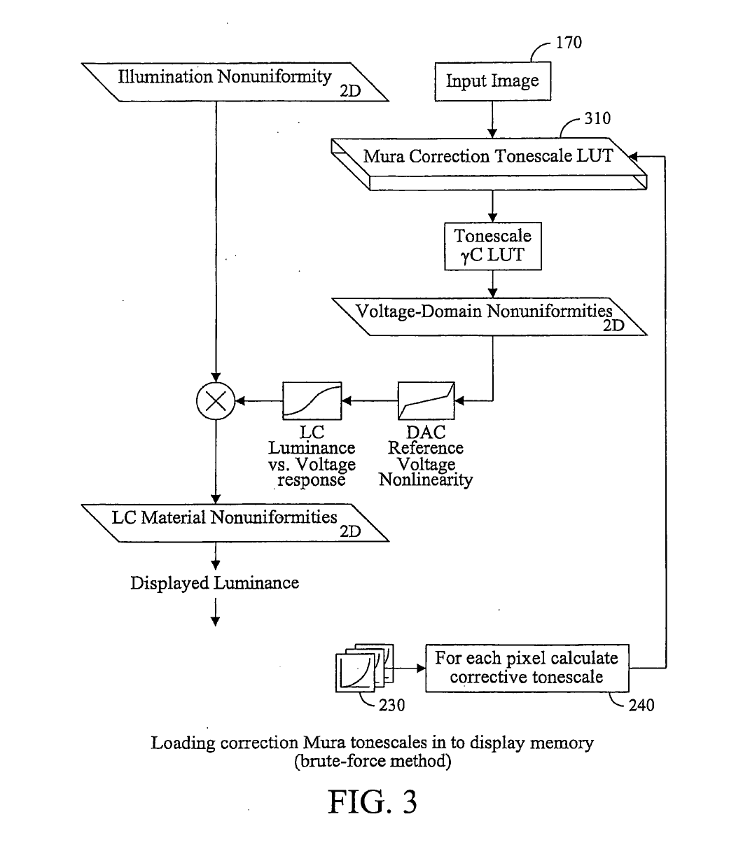

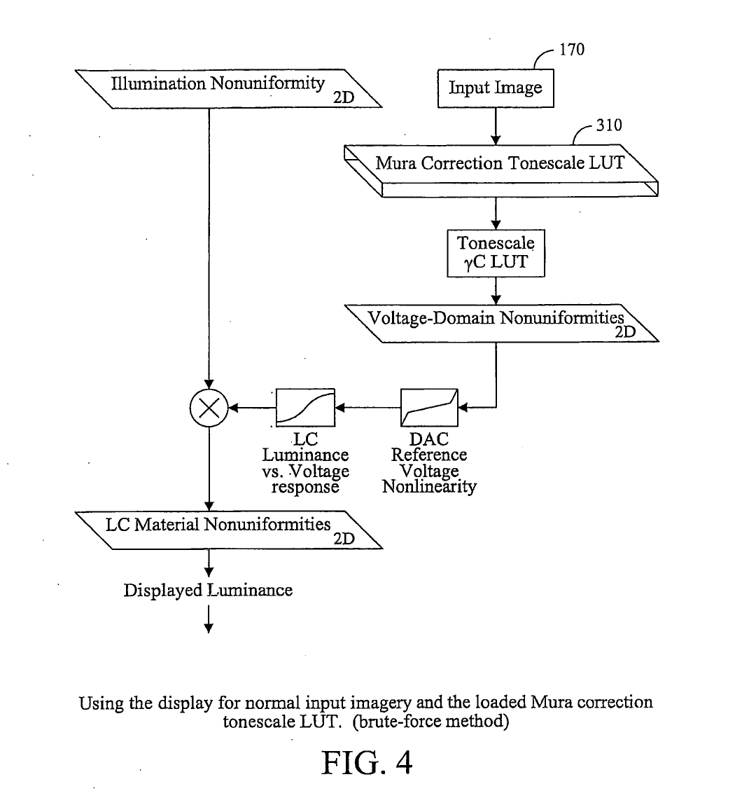

In summary, referring to FIG. 2, the process of detecting and correcting for mura defects may be done as a set of steps. First for a uniform test input image 220, the capture and generation of the corrective tone scale 230, 240 is created which may be expressed in the form of a look up table. Second, referring to FIG. 3 the corrective tone scale may be applied to a mura look up table 310 which operates on the frame buffer memory of the display. Third, referring to FIG. 4, the display is used to receive image data 170 which is modified by the mura look up table 310, prior to being displayed on the display.

The first step may use an image capture device, such as a camera, to capture the mura as a function of gray level. The camera should have a resolution equal to or greater than the display so that there is at least one pixel in the camera image corresponding to each display pixel. For high resolution displays or low resolution cameras, the camera may be shifted in steps across the display to characterize the entire display. The preferable test patterns provided to and displayed on the display include uniform fields (all code values=k) and captured by the camera. The test pattern and capture are done for all of the code values of the displays tone scale (e.g., 256 code values for 8 bit/color display). Alternatively, a subset of the tone scales may be used, in which case typically the non-sampled tone values are interpolated.

The captured images are combined so that a tone scale across its display range is generated for each pixel (or a sub-set thereof). If the display has zero mura, then the corrective mura tone scales would all be the same. A corrective tone scale for each pixel is determined so that the combination of the corrective tone scale together with the system non-uniformity provides a resulting tone scale that is substantially uniform across the display. Initially, the values in the mura correction tone scale look up table may be set to unity before the display is measured. After determining the corrective mura tone scale values for each pixel, it is loaded into the display memory as shown in FIG. 4. With the mura corrective tone scale data loaded any flat field will appear uniform, and even mura that may be invisible on ramped backgrounds, such as a sky gradient, will be set to zero.

While this mura reduction technique is effective for reducing display non-uniformities, it also tends to reduce the dynamic range, namely, the maximum to minimum in luminance levels. Moreover, the reduction in the dynamic range also depends on the level of mura which varies from display to display, thus making the resulting dynamic range of the display variable. For example, the mura on the left side of the display may be less bright than the mura on the right side of the display. This is typical for mura due to illumination non-uniformity, and this will tend to be the case for all gray levels. Since the mura correction can not make a pixel brighter than its max, the effect of mura correction is to lower the luminance of the left side to match the maximum value of the darker side. In addition, for the black level, the darker right side can at best match the black level of the lighter left side. As a result, the corrected maximum gets reduced to the lowest maximum value across the display, and the corrected minimum gets elevated to the lightest minimum value across the display. Thus, the dynamic range (e.g., log max-log min) of the corrected display will be less than either the range of the left or right sides, and consequently it is lower than the uncorrected display. The same reduction in dynamic range also occurs for the other non-uniformities. As an example, a high amplitude fixed pattern noise leads to a reduction of overall dynamic range after mura correction.

The technique of capturing the mura from the pixels and thereafter correcting the mura using a look up table may be relatively accurate within the signal to noise ratio of the image capture apparatus and the bit-depth of the mura correction look up table. However, taking into account that actual effects of the human visual system that will actually view the display may result in a greater dynamic range than would otherwise result.

By way of example, some mura effects of particular frequencies are corrected in such a manner that the changes may not be visible to the viewer. Thus the dynamic range of the display is reduced while the viewer will not otherwise perceive a difference in the displayed image. By way of example, a slight gradient across the image so that the left side is darker than the right side may be considered a mura effect. The human visual system has very low sensitivity to such a low frequency mura artifact and thus may not be sufficiently advantageous to remove. That is, it generally takes a high amplitude of such mura waveforms to be readily perceived by the viewer. If the mura distortion is generally imperceptible to the viewer, although physically measurable, then it is not useful to modify it.

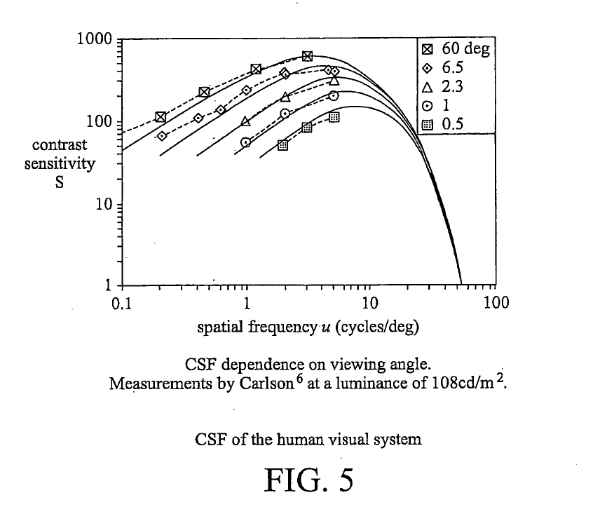

Referring to FIG. 5, one measure of the human visual system is a contrast sensitivity function (CSF) of the human eye. This is one of several criteria that may be used so that only the mura that is readily visible to the eye is corrected. This has the benefit of maintaining a higher dynamic range of the correction than the technique illustrated in FIGS. 3-5.

The CSF of the human visual system as a function of spatial frequencies and thus should be mapped to digital frequencies for use in mura reduction. Such a mapping is dependent on the viewing distance. The CSF changes shape, maximum sensitivity, and bandwidth is a function of the viewing conditions, such as light adaptation level, display size, etc. As a result the CSF should be chosen for the conditions that match that of the display and its anticipated viewing conditions.

The CSF may be converted to a point spread function (psf) and then used to filter the captured mura images via convolution. Typically, there is a different point spread function for each gray level. The filtering may be done by leaving the CSF in the frequency domain and converting the mura images to the frequency domain for multiplication with the CSF, and then convert back to the spatial domain via inverse Fourier transform.

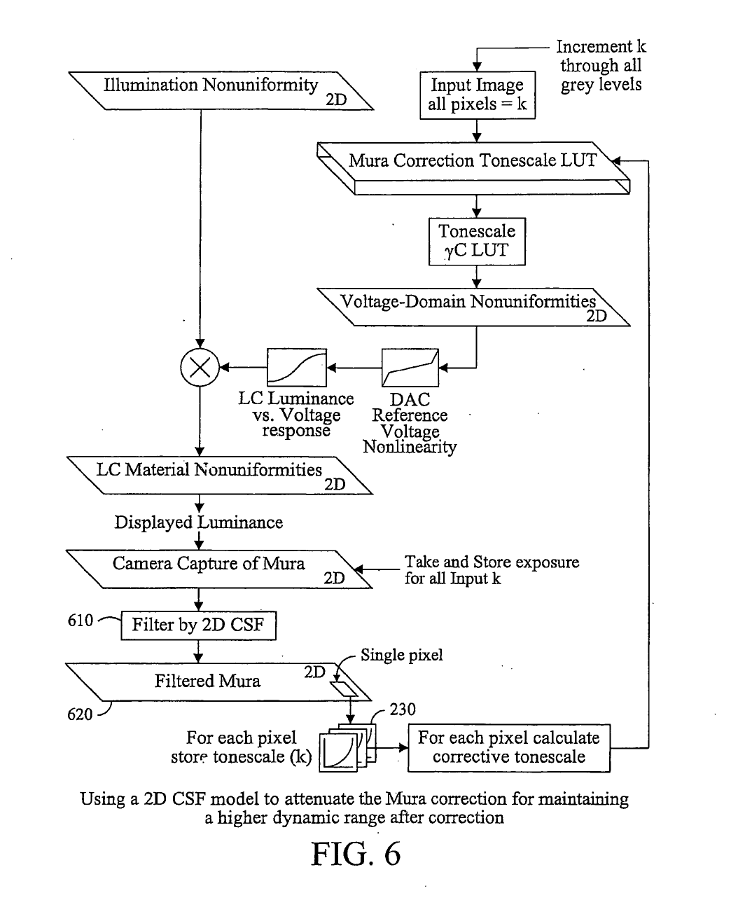

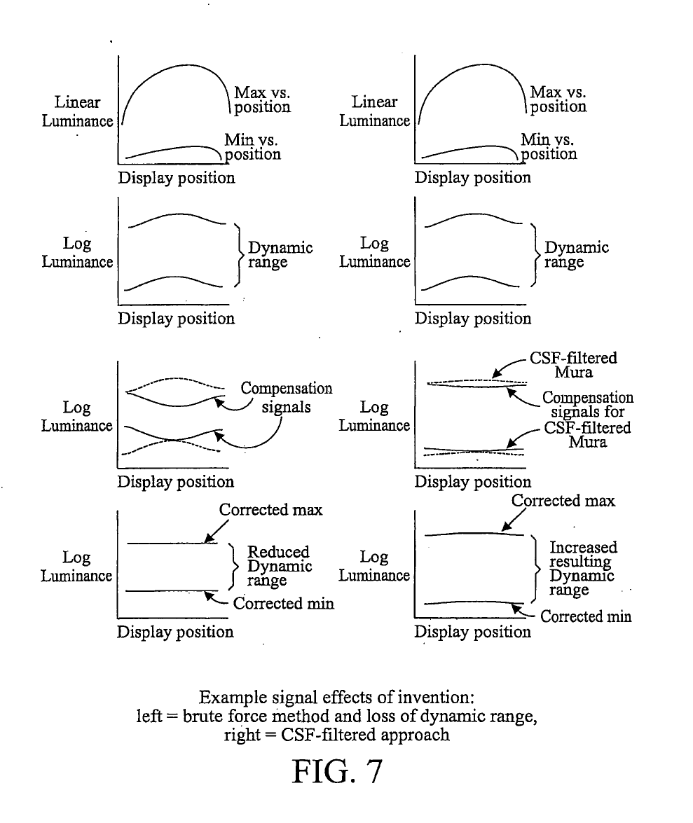

Referring to FIG. 6, a system that includes mura capture, corrective mura tone scale calculation, CSF filtered 610, 620, and mura correction tone scale look up table is illustrated. FIG. 7 illustrates the effects of using the CSF to maintain bandwidth.

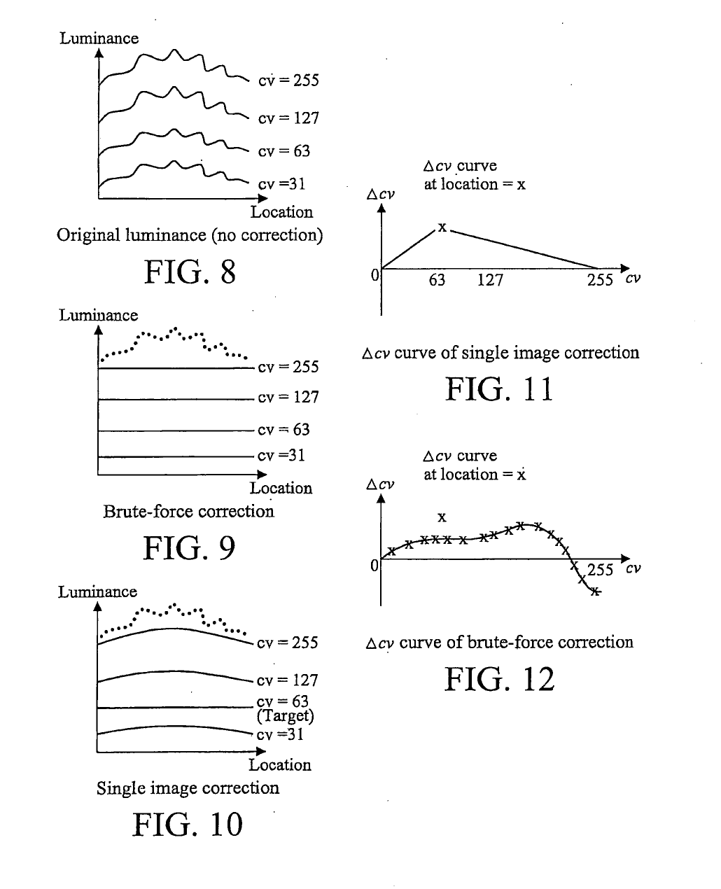

It is possible to correct for mura distortions at each and every code value which would be approximately 255 different sets of data for 8-bit mura correction. Referring to FIG. 8, the luminance at each code value is illustrated for a selected set of code values across the display. In many displays, the luminance toward the edges of the display tend to be lower than the center of the display. This may be, in part, because of edge effects of the display. Referring to FIG. 9, a brute-force mura correction technique for each and every code value for all pixels of the display results in a straight line luminance for each code value across the display. It is noted that the resulting luminance for a particular code value is selected to be the minimum of the display. Accordingly, it was observed that in the event that a particular region of the display has values substantially lower than other regions of the display, the result will be a decrease in the luminance provided from the display for a particular code value, in order to have a uniform luminance across the display.

Referring to FIG. 10, to increase the dynamic range for portions of the display, it is desirable to determine a mura correction for a particular code value, such as code value 63. Thus at code value 63 the resulting mura across the display will be corrected or substantially corrected. The mapping used to correct for code value 63 is then used at the basis for the remaining code values to determine an appropriate correction. The resulting code values will tend to result in arched mura correction curves. The resulting curved mura curves result in an increase in the dynamic range of regions of the display while displaying values in a manner that are difficult to observe mura defects.

In some cases, it is desirable to determine a mura correction for a particular code value, such as code value 63, that includes a curve as the result of filtering. The filtering may be a low pass filter, and tends to be bulged toward the center. The curved mura correction tends to further preserve the dynamic range of the display. The curved mura correction may likewise be used to determine the mura correction for the remaining code values.

It is to be understood, that the mura correction may further be based upon the human visual system. For example, one or more of the mura curves that are determined may be based upon the human visual system. Moreover, the low pass filtered curve may be based upon the human visual system. Accordingly, any of the techniques described herein may be based in full, or in part, on the human visual system.

The memory requirements to correct for mura for each and every gray level requires significant computational resources. Additional approaches for correcting mura are desirable. One additional technique is to use a single image correction technique that uses fewer memory resources, and another technique is to use a multiple image correction technique which uses fewer memory resources with improved mura correction. The implementation of the conversion from the original input images to mura corrected output images should be done in such a manner that enables flexibility, robustness, and realizes efficient creation of corrected output images by using interpolation.

The single image correction is a mura correction technique that significantly reduces the memory requirements. Comparing with brute-force correction, single image correction corrects the mura of just only one gray level (e.g. cv=63 in FIGS. 4, 5, 6) instead of every gray level of the brute-force correction. Brute-force correction intends to correct every gray level for all pixels. FIG. 9 shows only several gray levels for simplicity of illustration.

In particular, in single image correction the correction code value (Δcv) of other gray levels without the target to correct are determined by interpolation assuming Δcv=0 at gray level is 0 (lower limitation) and 255 (upper limitation) because mura of intermediate gray levels is more visible, as illustrated in FIG. 11. On the other hand, brute-force method calculates the correction code value of all of gray levels, theoretically speaking, as illustrated in FIG. 12. In some cases, it is desirable to also provide white mura correction (Δcv=255), in addition to intermediate grey levels, to provide increased uniformity.

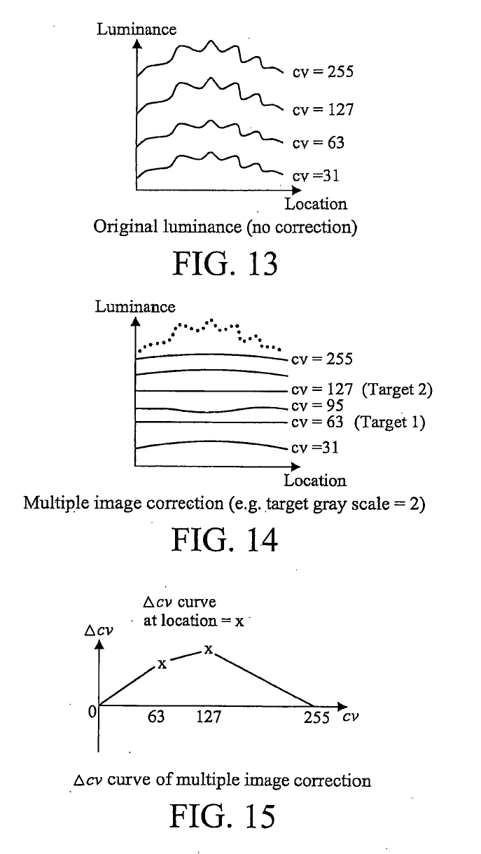

In some cases, to provide more accurate mura correction while maintaining the dynamic range and limiting the storage requirements, a multiple mura correction technique may be used. Compared with brute-force correction, multiple image correction corrects the mura based upon several gray levels (e.g. cv=63 and 127), as illustrated in FIGS. 13 and 14.

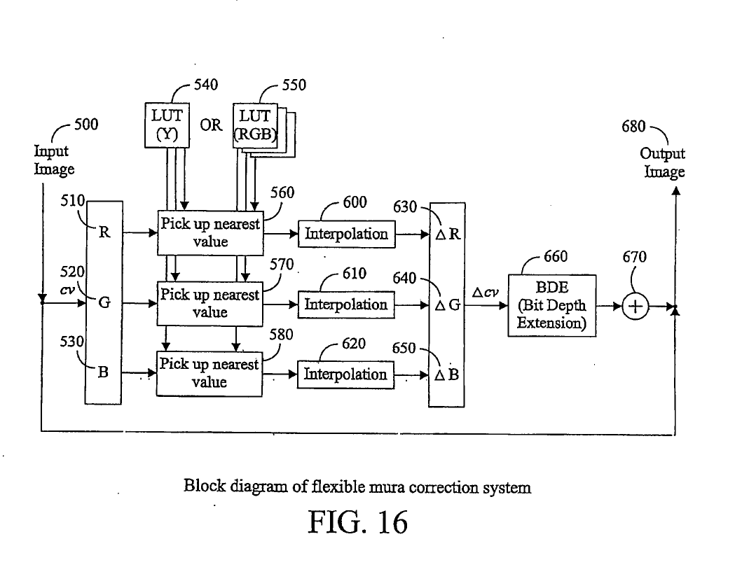

Referring to FIG. 15, in multiple image correction, the correction code value ( Δcv ) of other non-target gray levels are determined by interpolation assuming Δcv=0 at gray level 0 (lower limitation) and 255 (upper limitation) because mura of intermediate gray level is more visible. Once the Δcv of the target gray levels are determined by using one of the proposed techniques, such as brute-force, single image, multiple image, and HVS-based correction, input images to display can be corrected by reference of LUT and interpolation as illustrated in FIG. 16.

Referring to FIG. 16, the mura correction system is flexible for implementation because the image processing does not depend on characteristics of each panel. Also, the system has the capability to adapt to other mura correction techniques. The input image 500 may be separated by color planes into R 510, G 520, and B 530. A luminance look up table 540 or a color dependant look up table 550 may be used to select near code values 560, 570, 580 within the respective look up table for the respective pixel. The selected code values are interpolated 600, 610, 620, to determine an interpolated code value. The interpolated code values 600, 610, 620 are then used for determining 630, 640, 650 the adjustment for the respective pixel. It is to be understood that other suitable color spaces may likewise be used, such as for example, YUV, HSV. A bit depth extension process 660 may be used, if desired. The output of the bit depth extension process 660 is added 670 to the input image 500 to provide a mura corrected output image 680.

Color mura correction aims to correct non uniformity of color by using color based LUT. The same correction techniques (e.g. brute-force, HVS based, single image, multiple image) are applicable to using color mura LUT. The primary difference between luminance mura correction and color mura correction is to use colored gray scale (e.g. (R, G, B)=(t, 0, 0), (0, t, 0), (0, 0, t)) for capturing images. If the display is RGB display, the data size is 3 times larger than the luminance correction data. By correcting each color factor separately can achieve not only luminance mura correction but also color mura correction.

Over time, as a display is being used, the display tends to experience aging of the pixel grid. The aging creates, among other things, undesirable patterns (i.e. deviations from uniformity) which manifest themselves in the images displayed on the display. The resulting characteristics of such aging may be generally referred to as mura. While the aging effects for mura may exist with cathode tube backlight LCD displays, such aging effects are more pronounced with respect to light emitting diode based LCD displays, and organic light emitting diode displays.

The traditional high resolution camera based mura compensation technique employs expensive high resolution cameras. In addition, to achieve accurate mura measurement the mura setup requires accurate positioning of the display with respect to the camera in a controlled lighting environment. The resulting mura measurements are used to adjust the images displayed on the display. In the event the mura compensation is not properly set up, the resulting image data tends to exhibit moiré, keystoning artifacts, and barrel distortion. It is inconvenient to ship a display back to the factory, which may be in a different continent, in order to have the display re-calibrated to adjust mura effects that occur as a display ages.

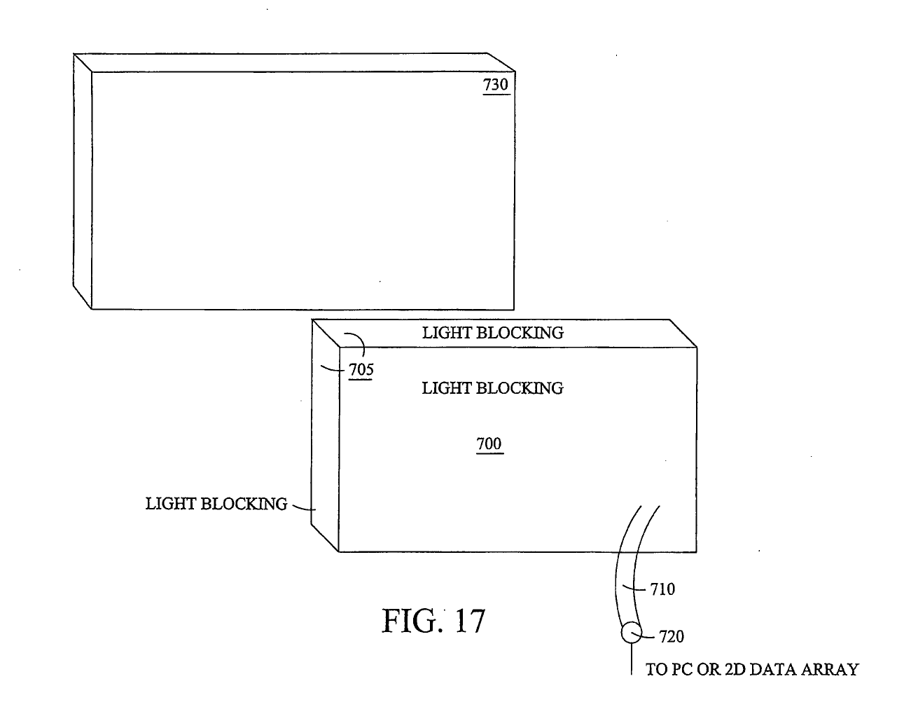

By using a different image capture system, a modified system may be developed that can measure the mura of a display in a manner that is not as sensitive to setup variability, can be performed by a qualified technical technician or the display owner or any other person, and calculate mura correction data as a result. Referring to FIG. 17, a modified mura capture system includes a light shield 700. The light shield 700 is designed to fit over a major portion of the light emitting portions of the display, and preferably exactly over all of the light emitting portions of the display 730. The light shield 700 is preferably constructed using diffusion screens, light guides, or other light impeding material so that the light shield 700 blocks ambient light, or otherwise substantially impedes ambient light from reaching the portion of the display under the light shield 700. For example, the light shield 700 may be constructed using a diffusion screen that has light blocking coatings on the externally facing surfaces 705 to block ambient light. The diffusion screen light shield 700 may be in pressing engagement with the display so that light from the display is diffused into the diffusion screen in a controlled manner.

The light shield 700 preferably fits snugly into the bezel of the display so that overall registration of the light shield 700 with respect to the display is known. In the event that the light shield 700 is not reliability registered with respect to the display, such as the light shield 700 being smaller than the light emitting regions of the display, a registration algorithm is used. This is effectively done by turning on the emitting elements in isolation.

The light shield 700 includes an optical coupler 710 coupled to a light sensor 720. The optical coupler 710 may be any structure or device, separate or integrated with the light shield 700, to direct light to the light sensor 720. The light sensor 720 may be any device that can sense the light originating from the display, such as for example, a photosensitive element. In this manner, light from the display will be substantially isolated from external ambient light and a portion of the light from the display will pass through the optical coupler 710 to the light sensor 720. Preferably substantially 100% of the light will pass through the optical coupler 710 to the light sensor 720.

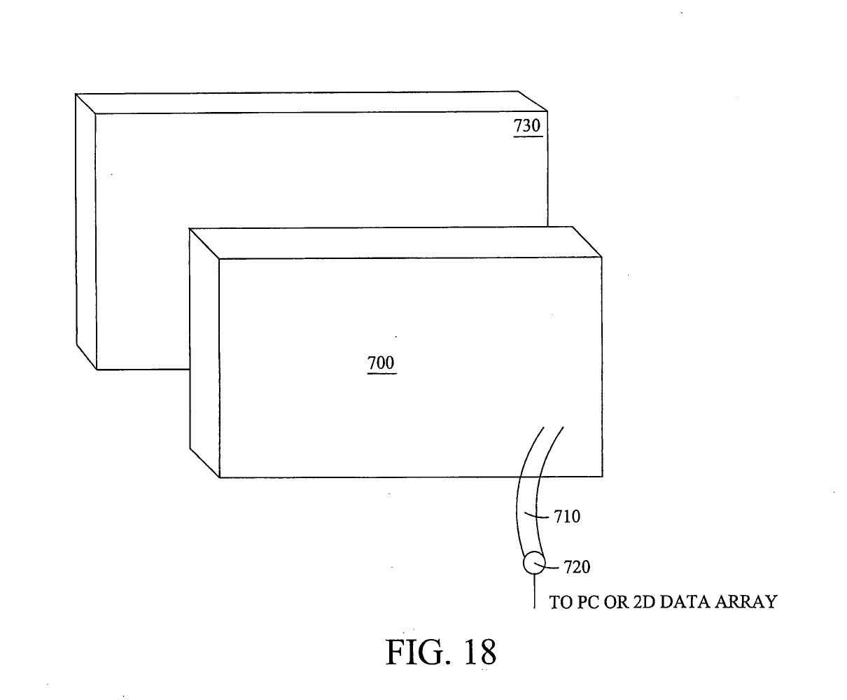

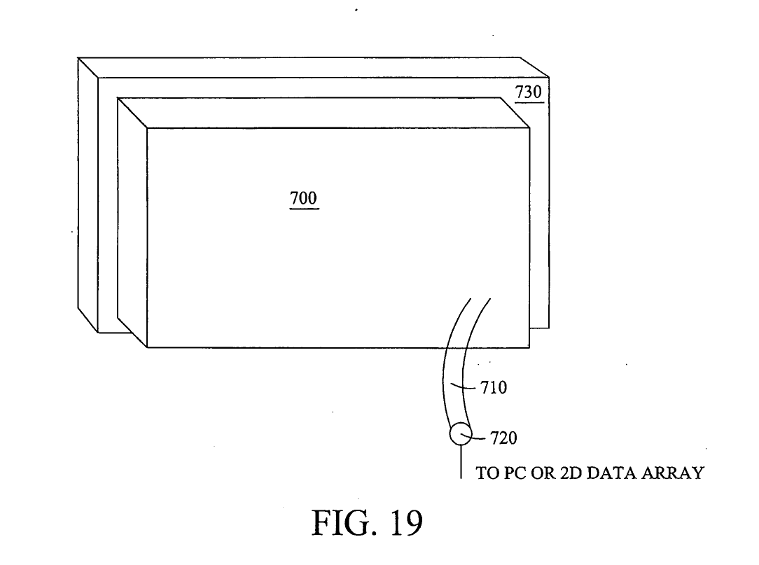

Referring to FIG. 18, the light shield 700 is aligned with the display 730. Referring to FIG. 19, the light shield 700 is brought into engagement with the display 730 thereby shielding the light emitting portion of the display 730 and the light sensor 720 from ambient light. Any particular pixel(s) of the display 730 that is illuminated will result in the light sensor 720 sensing light. However, the response detected by the light sensor 720 will be affected by the distance due to light guide attenuation of the pixel to the optical coupling junction on the light shield 700. This deviation in received light may be normalized by calibration of the device. One technique for calibration of the light guide/coupler/sensor setup is to use a sufficiently mura-compensated display. By sequentially illuminating each pixel, or sub-pixel thereof, a corresponding value may be determined by the light sensor 730. The value is the relationship (gain/offset) of the pixel position of the display for the light sensor after digitization.

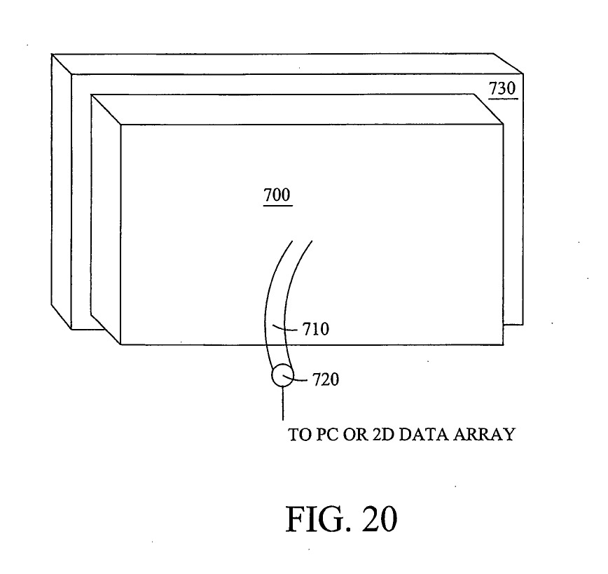

As illustrated in FIG. 19, the optical coupler 710 is preferably substantially offset toward the edge of the display. This tends to reduce the potential of introducing correction artifacts in the mura correction data in the display around the optical coupler 710. An exemplary position is the bottom right corner of the display. Referring to FIG. 20, another embodiment includes the optical coupler 10 substantially centered in the middle of the display. The resulting calibration data may be somewhat symmetrical and accordingly may be calculated, based upon a function, if desired. In addition, the calibration data may tend to have a smaller range.

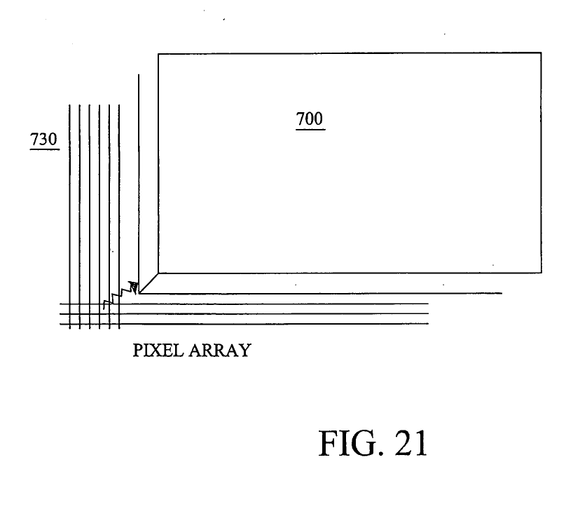

Referring to FIG. 21, the light shield 700 directs light from the pixel array of the display to the optical coupler. The pixels (or sub-pixels) of the display are preferably addressed in a sequential manner, with a particular pixel set to a gray level (preferably the max level) with the remainder of the pixels being set to black (e.g., off). In this manner, the light from an individual pixel may be sensed by the light sensor 730. The wavy arrow illustrates the light from a pixel going into the diffusion screen, while the other surfaces are light reflective or light absorbing to provide additional optical isolation from the remaining surfaces.

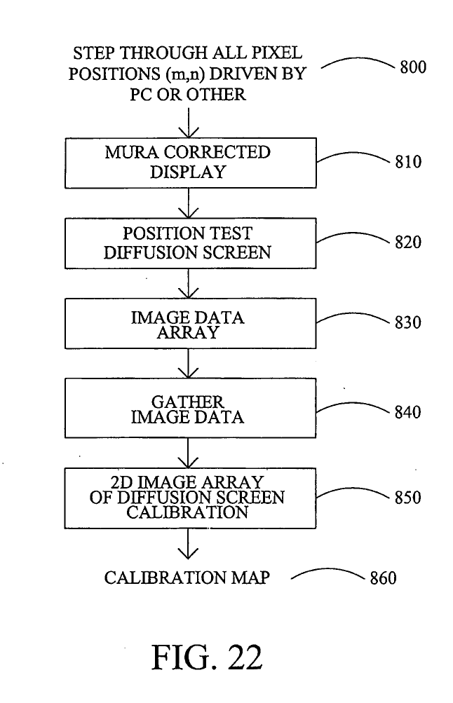

Referring to FIG. 22, one technique for determining the calibration data for subsequent mura correction is illustrated. Each of the pixels, or subpixels thereof, are sequentially selected 800. A mura corrected display 810 may be used as an illumination source over which is positioned 820 the light shield 700. The array of pixels are illuminated, sequentially one at a time, for the image data array 830. The sensed light by the light sensor 730 is summed 840 thereby forming a two dimensional image array of diffusion screen mura calibration data 850. In general, it is expected that the light sensor output will have an approximately 1/r falloff with distance. The resulting calibration data 850 in the form of a calibration map 860 is saved with each light shield 700, or otherwise associated with each light shield 700.

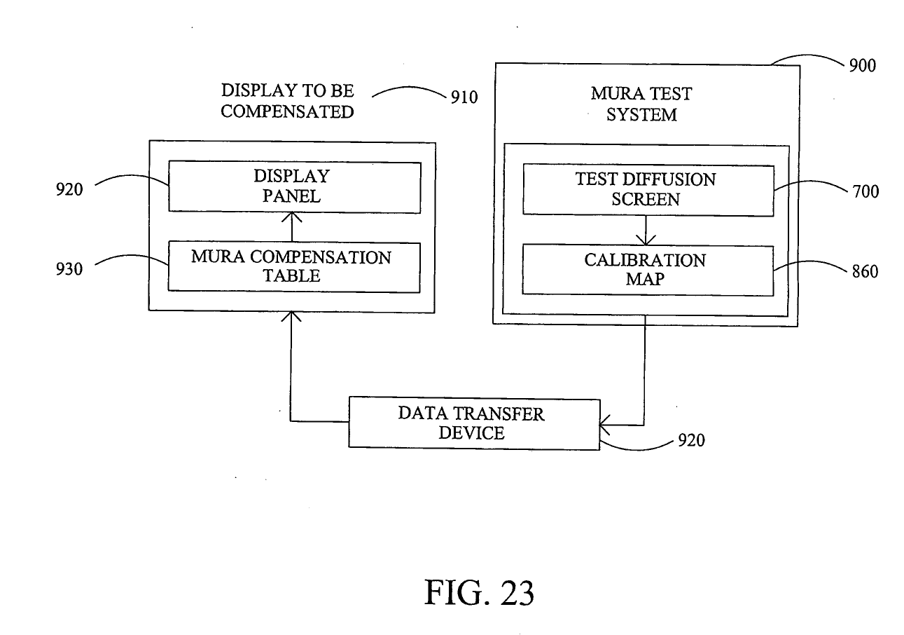

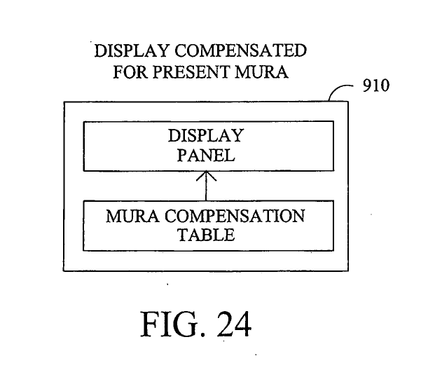

The light shield 700 together with calibration data may be used to calibrate other devices. Referring to FIG. 23, a mura test system 900 may be used to measure characteristics of an unknown display 910, such as one where the mura has changed due to aging (900 fits over 910, like 700 fits over 730 in FIG. 2). The test diffusion screen 700 is used to test the display panel 920. After testing the display 920, a resulting calibration map 860 is generated by the test system 900 which indicates mura corrections. The updated mura correction data is transferred 920 to the display 910. Preferably, the display 910 includes an external connector to which the test system 900 may connect to permit the updating of the mura compensation table 930 internal to the display. In some cases, the mura compensation table 930 may be an additional table of compensation data, so that the display 910 will have a pair of tables for correction of mura artifacts. The use of a secondary mura compensation table, while using additional memory, eliminates the need to change the primary mura compensation table which may also include data to adjust for other artifacts. The mura compensation table 930 is then used when rending images on the display panel 920. In some cases, the existing mura compensation table is updated, or otherwise read, modified, and updated in the display. Referring to FIG. 24, the mura test system 900 is removed from the display to be compensated 910.

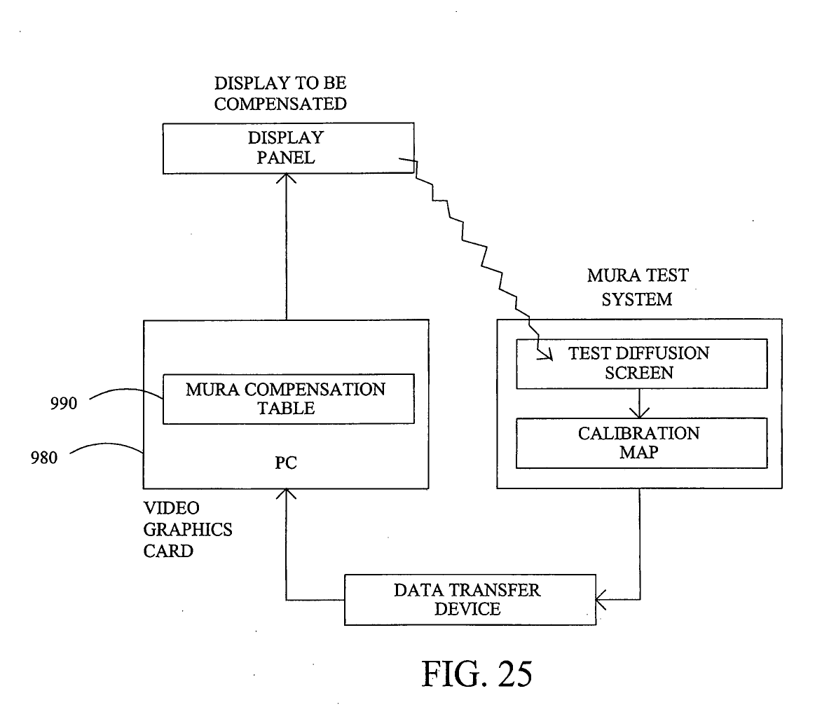

In some cases, the display does not include the capability of updating its mura compensation table or otherwise does not include a mura compensation table. Referring to FIG. 25, in many cases the television or otherwise the computer monitor is driven using a video graphics card within a computer 980. The video graphics card includes a mura compensation table 990 or otherwise a data table that may be used to adjust the mura of the display. Similarly, the data table in the graphics card may be updated to modify the mura.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A system for characterizing a display comprising:
(a) a light gathering element sized to engage over a major portion of said display;
(b) said light gathering element adapted to substantially inhibit light from reaching a region between said light gathering element and said display when said light gathering element is said engaged with said display;
(c) an optical coupling element associated with said light gathering element to direct light emanating from said display to a light sensitive element;
(d) based upon sensing light by said light sensitive element determining corrective data for said display so as to reduce the mura effects of said display.

2. The display of claim 1 wherein the lower tone scale of said display is substantially mapped into said corrective data.

3. The display of claim 1 wherein the higher tone scale of said display is substantially mapped into said corrective data.

4. The display of claim 2 wherein the higher tone scale of said display is substantially mapped into said corrective data.

5. The display of claim 3 wherein said backlight and state of a liquid crystal material of said display would be greater than the maximum luminance capable of said display if said display was not modified to reduce said mura effects.

6. The display of claim 1 wherein said display includes a plurality of light emitting diodes.

7. The display of claim 1 wherein said display includes organic light emitting elements.

8. The display of claim 1 wherein said light sensitive element is a photo sensor.

9. The display of claim 1 wherein a plurality of pixels of said display is illuminated in a sequential manner.

10. The display of claim 1 wherein a plurality of sub-pixels of said display is illuminated in a sequential manner.

11. The display of claim 1 wherein said corrective data is applied to said display.

12. The display of claim 1 wherein said corrective data is applied to a graphics card associated with said display.

13. The display of claim 1 wherein said gathering element includes a light blocking material on its sides and a surface thereof.

14. The display of claim 1 wherein said display includes a plurality of light emitting elements that illuminate a liquid crystal layer.

15. The display of claim 9 wherein quantized sensor values are synchronized to locations in a mura compensation table.

16. The display of claim 11 wherein quantized sensor values are synchronized to locations in a mura compensation table.

17. A display for adjusting compensation comprising:
(a) said display including data used by said display to reduce the mura effects that would have otherwise occurred if said mura data were not used;
(b) said display including an external connector;
(c) said display receiving additional data through said external connector wherein said data is used by display to modify mura effects that would have otherwise occurred if said additional data were not used.
